(19) United States
(12) Patent Application Publication
(10) Pub. No.: US 2023/0419624 A1
(43) Pub. Date: Dec. 28, 2023

(54) SYSTEM FOR HYBRID VIRTUAL AND PHYSICAL EXPERIENCES

(71) Applicant: Alt Ethos Ltd., Fort Collins, CO (US)

(72) Inventor: Ethan R. Bach, Fort Collins, CO (US)

(21) Appl. No.: 18/340,558

(22) Filed: Jun. 23, 2023

Related U.S. Application Data
(60) Provisional application No. 63/354,950, filed on Jun. 23, 2022.

(51) Int. Cl. G06T 19/00; G06T 13/40; G10L 21/0208

(52) U.S. Cl. CPC G06T 19/006; G10L 21/0208; G06T 13/40

(57) ABSTRACT

Systems, methods, and devices are disclosed herein for creating a virtual-physical hybrid experience that improves the user experience of remotely attending an in-person event by seamlessly integrating the virtual presence of one or more remote users into the in-person event while providing the remote users with a fuller level of engagement with other persons at the event. In an implementation, a digital display system creates an interface between a physical location and a virtual or simulated environment. The digital display system enables two-way audio and video transmission between the physical location and a simulation of the physical location, whereby a user remote from the physical location can view and interact with persons at the physical location via a portal within the simulation, and a user at the physical location can view and interact with a representation of a remote user within the simulation displayed at the physical location.

### RELATED APPLICATIONS

This application is related to and claims the benefit of priority to U.S. Provisional Patent Application No. 63/354,950, entitled SYSTEM FOR HYBRID VIRTUAL AND PHYSICAL EXPERIENCES, filed on Jun. 23, 2022, the contents of which are hereby incorporated by reference in their entirety.

### TECHNICAL FIELD

Aspects of the disclosure are related to the field of real-time digital transmission of audio and video between remote devices.

### BACKGROUND

In the event space, computer-mediated virtual events provide greater accessibility over in-person events by obviating the need for attendees to be physically present and by accommodating more attendees than a physical venue may be able to accommodate. In a fully virtual event, attendees interact with other attendees through videoconferencing software. Though that interaction is largely face-to-face dialogue, it can also include whiteboard displays, chat rooms, and private messaging. Moreover, all of the videoconference attendees are generally on equal footing in terms of their ability to participate.

Despite the greater accessibility, virtual events are distant by nature and lack the person-to-person engagement of in-person events. For example, in-person events are more conducive to networking than virtual events because virtual events lack opportunities for organic engagement—striking up a spontaneous conversation with another attendee, for example. In addition, verbal communication can be awkward when mediated over a communication network.

Augmenting an in-person event with a virtual component, such as live-streaming particular sessions or speakers, provides a remote attendee with only a limited, unilateral means to participate in the event. For a remote attendee to actively participate in a live event requires burdensome solutions such as designating a person at the event to act as a proxy for the remote attendee. Thus, a remote attendee of an in-person event receives a lesser experience compared to that of a fully virtual or fully in-person event.

### OVERVIEW

Systems, methods, and devices are disclosed herein for creating a virtual-physical hybrid experience that improves the user experience of remotely attending an in-person event by seamlessly integrating the virtual presence of one or more remote users into the in-person event while providing the remote users with a fuller level of engagement with other persons at the event.

In an implementation, a digital display system creates an interface between a physical event or location and a virtual or simulated environment presented by application platform executing on a remote server. The digital display system enables two-way audio and video transmission between the physical location and a simulation of the physical location, whereby a user remote from the physical location can view and interact with persons at the physical location via a portal within the simulation, and a user at the physical location can view and interact with a representation of a remote user within the simulation displayed at the physical location.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment of a digital interfacing system in an implementation.

FIG. 2 illustrates a digital interfacing process in an implementation.

FIG. 3 illustrates an operational scenario of a digital interface system in an implementation.

FIG. 4 illustrates another operational scenario of a digital interface system in an implementation.

FIG. 5 illustrates another operational scenario of a digital interface system in an implementation

FIG. 6 illustrates a workflow for operating a digital interfacing system in an implementation.

FIG. 7 illustrates an operational scenario of a digital interface system in an implementation.

FIG. 8 illustrates a computing system suitable for implementing the various operational environments, architectures, processes, scenarios, and sequences discussed below with respect to the other Figures.

### DETAILED DESCRIPTION

Various implementations are disclosed herein which describe a digital interface system, method of operation, and devices which allow remote attendees of a live, in-person event to actively participate in the event and which allow in-person attendees of the event to actively participate with remote attendees as if the remote attendees were attending the event in person, standing in front of the live attendees. Technology is disclosed herein for creating a virtual-physical hybrid experience that improves the user experience of remotely attending an in-person event by integrating the virtual presence of one or more remote users into the in-person event while providing the remote users with a fuller level of engagement with the in-person attendees and other remote users.

In a brief example, a digital display system creates an interface between an in-person event and a virtual or simulated environment accessible by remote event participants or users. Situated at the in-person event, the digital display system transmits and receives real-time audio and video using a display screen, one or more speakers, one or more cameras, and one or more microphones. In an implementation, the display screen is sized large enough to display a life-size or near-life-size representation of a remote user.

From the virtual side of the interface of the digital display system, a remote user attends and participates in the in-person event via a computing device which receives and displays a virtual or simulated environment, such as a “metaverse,” executing on a server-based virtual environment application platform. In an implementation, the virtual environment comprises a virtual forum which has one or more portals, each of which provides access to various physical locations at the in-person event, such as portals to a main gathering area, to various break-out rooms, and to areas designated for one-on-one meetings and networking. Access to a physical location via a portal comprises receiving live video and audio feeds from the physical location transmitted by the one or more cameras and microphones of the digital display at that location. In an implementation, the video and audio feeds from a digital display are transmitted over one or more wired or wireless communication networks to the remote user's computing device, where the virtual environment application software presents the audio and video transmission at a portal such as a virtual window or doorway on the virtual forum.

Within the browser-based virtual environment, the remote user controls a dynamic, full-body representation of the remote user, i.e., an avatar, and directs the avatar to the virtual forum representing the in-person event. Within the virtual forum, the remote user in the form of the avatar can participate in the in-person event via real-time audio and video transmission, i.e., the user can see, hear, and communicate with other attendees and attend activities at the event. By simulating the in-person event as the virtual forum, the remote user obtains a fuller sensory, and therefore participatory, experience. Moreover, the system allows the remote user to “visit” any areas of the event where a digital display is located.

From the in-person side of the interface of the digital display system, in-person attendees can see and hear avatar representations of remote users in the virtual forum, enabling the attendees to engage with a remote user via the remote user's avatar. In a brief example, an in-person attendee views a digital display screen and sees one or more avatars within the virtual forum from a perspective that simulates the view looking into the virtual forum through a window or portal. Within the virtual environment, each avatar represents a remote user or attendee who may be recognizable by his or her avatar. A remote user, seeing the in-person attendee at the portal corresponding to the digital display, may direct his or her avatar to move toward, i.e., walk, to the portal to speak with the in-person attendee as if the remote attendee was physically present in the room and standing before the in-person attendee. The digital interface system seamlessly integrates the virtual presence of the remote user into the in-person event, enabling the remote user and in-person attendees to interact as if the remote user was at the event in person. Thus, the technical effect of the virtual-physical hybrid system technology as disclosed herein is to simulate a situation where all of the users, remote and in-person, are physically present together in the same room even though the remote users may be attending from a variety of locations around the world.

In various implementations, the virtual environment application software comprises an avatar module which defines the physical characteristics and movements of an avatar to closely resemble the physical characteristics and movements of the remote user, thereby creating a more realistic simulation of the remote user for in-person attendees. For example, the avatar may dynamically simulate facial expressions of the remote user as the remote user is speaking, such as by contorting the mouth of the avatar according to what the remote user is saying. Simulating the physical characteristics and movements of the remote user is more conducive to communication between the remote user and an in-person attendee by enabling not just verbal communication but communication by body language as well. In various implementations, a user can design his or her avatar or can modify a predefined avatar according to personal preferences.

It may be appreciated that although the technology is discussed in the context of an event attended by multiple in-person attendees and at least one remote user, the technology can also be used in contexts comprising one-on-one interactions or contexts comprising multiple remote users interacting with a single in-person attendee. In various implementations, the digital display system may comprise a hologram generator which generates and displays a holographic representation, i.e., hologram, of the remote user or the remote user's avatar.

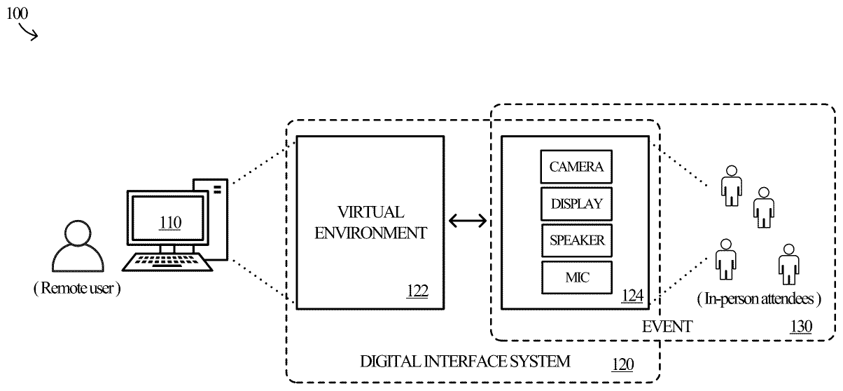

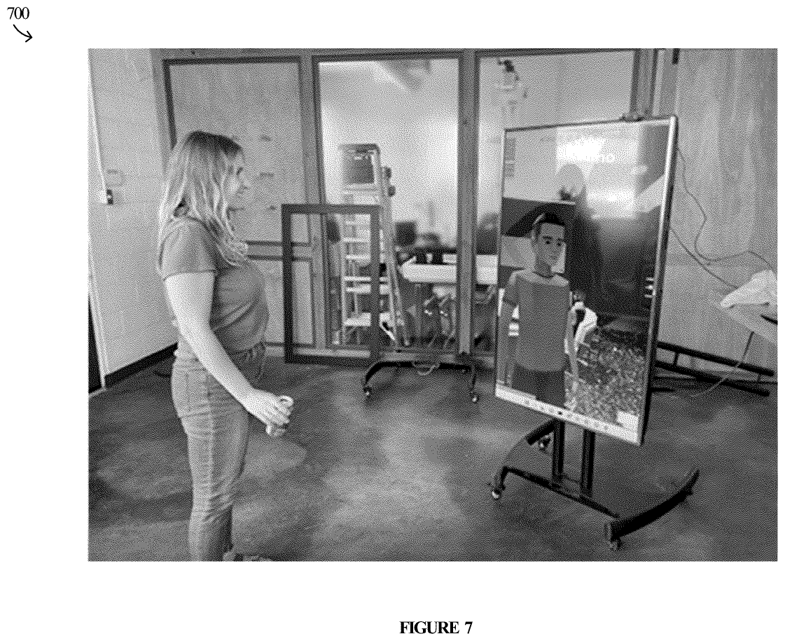

FIG. 1 illustrates an operational environment 100 in an implementation. Operational environment 100 includes computing device 110, digital interface system 120, and event 130. Computing device 110 comprises any computing device capable of operating virtual environment application software. Computing device 110 may also comprise any computing device capable of accessing a browser-based virtual environment application executing on a remote server. Examples of computing device 110 include personal computers, tablet computers, mobile phones, and any other suitable devices, of which computing device 801 in FIG. 7 is broadly representative.

Digital interface system 120 comprises virtual environment 122 and digital display device 124. Virtual environment 122 is presented by virtual environment application software executing on or displayed by computing device 110. A digital interface system is operatively connected to or embedded within the virtual environment application which creates an interface for communication between the virtual environment and a physical (i.e., real-world) location.

Digital display device 124 comprises one or more cameras, a digital display, one or more speakers, and one or more microphones. The cameras and microphones of digital display device 124 are devices capable of transmitting video and audio from the physical environment of the device to computing device 110 for presentation to a remote user via one or more wired or wireless communication networks. The digital display and speakers of digital display device 124 are devices capable of projecting video and audio received from a remote computing device such as computing device 110 via one or more wired or wireless communication networks. In an implementation, the digital display of the digital display device 124 is sized to display a life-size or full-body image of an avatar or of a remote user.

In various implementations, digital interface system 120 comprises noise-suppressing software or devices to reduce or cancel background noise and/or enhance the voice of a speaker. Digital interface system 120 may also comprise software or devices to reduce or eliminate audio feedback, such as de-looping software or hardware. Digital interface system 120 may also comprise systems or software for reducing audio or video latency in transmission between the various hardware components of the system. In still other implementations, digital display device 124 and/or computing device 110 may comprise a high-resolution camera (e.g., 4K resolution). It may be appreciated that a variety of audio and video devices can be used in the digital interface system.

Event 130 comprises a physical location of digital display device 120. Digital display device 124 captures and transmits audio and video from the event 130 for transmission via digital interface system 120 to remote computing devices such as computing device 110. Digital display device 124 also receives and presents audio and video received from remote computing devices of remote users, whereby attendees of event 130 can view and interact with remote users via digital display device 120.

In operation, computing device 110 of a remote user executes a virtual environment application which presents virtual environment 122 to the remote user. The remote user interacts with virtual environment 122 through a representation of the user, i.e., an avatar of the user. Within a virtual forum of virtual environment 122 is a representation of event 130. The remote user directs his or her avatar to maneuver through virtual environment 122 to the virtual forum. At the virtual forum, the remote user is presented with one or more portals each of which presents livestream audio and video captured by a digital display device such as digital display device 124. In-person attendees for event 130 are similarly presented audio and video of the avatar of the remote user by the digital display and speakers of digital display device 124. In this way, digital display device 124 enables two-way communication between event attendees and the remote user. Moreover, other remote users present in the virtual forum may also “visit” the portal alongside the remote user at computing device 110, enabling interaction between multiple remote parties and in-person attendees.

The software components of digital interface system 120 may be hosted by an online service which provides digital content to and transmits livestream audio and video between endpoints such as computing device 110 and digital display device 124. For example, the online service may host all or portions of the virtual environment application software presenting virtual environment 122. The online service may employ one or more server computers co-located or distributed across one or more data centers connected to computing device 110 and digital display device 124. Examples of such servers include web servers, application servers, virtual or physical (bare metal) servers, or any combination or variation thereof, of which computing device 801 in FIG. 7 is broadly representative. Computing device 110 may communicate with the online service hosting digital interface system 120 via one or more internets and intranets, the Internet, wired and wireless networks, local area networks (LANs), wide area networks (WANs), and any other type of network or combination thereof.

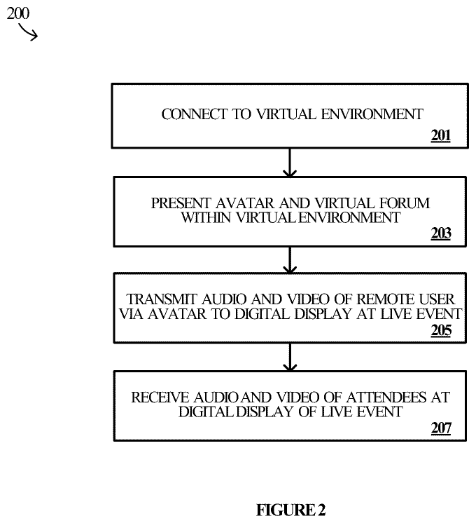

FIG. 2 illustrates an interfacing process in an implementation, herein referred to as process 200. Process 200 may be implemented in program instructions in the context of any of the software applications, modules, components, or other such elements of one or more computing devices. The program instructions a digital interface system, such as digital interface system 120, to operate as follows.

In operation, a virtual environment application operating on a user's computing device logs into or connects to a virtual environment including a virtual forum (step 201). The virtual forum is a representation of a live event within the virtual environment. The virtual environment connects to the live event via a digital display device at the live event which is represented as a portal in the virtual forum. The portal simulates a window on the live event, providing livestream audio and video from the event as captured by the display device. The virtual environment application may be a client-side application stored on the computing device or it may be browser-based application accessed from an application platform hosted on a remote server. The virtual environment is accessible by other users on other computing devices connecting to the virtual environment platform. Each user has an avatar which acts as a proxy for the user within the virtual environment, and by which the user can interact with other users and with the virtual environment.

Next, the application presents an avatar of the user in a virtual environment (step 203). The computing device receives user input directing the virtual environment application to maneuver the avatar toward the portal in the virtual forum. The application displays the view and sound captured by the digital display device at the live event at the portal (step 205). The application receives audio from the remote use via a microphone on the computing device and transmits the audio along with a video of the user's avatar to the display device at the live event (step 207). In this way, in-person attendees at the live event can communicate with remote attendees via the display device. It may be appreciated that steps 205 and 207 are interchangeable and can occur multiple times during the user's attendance.

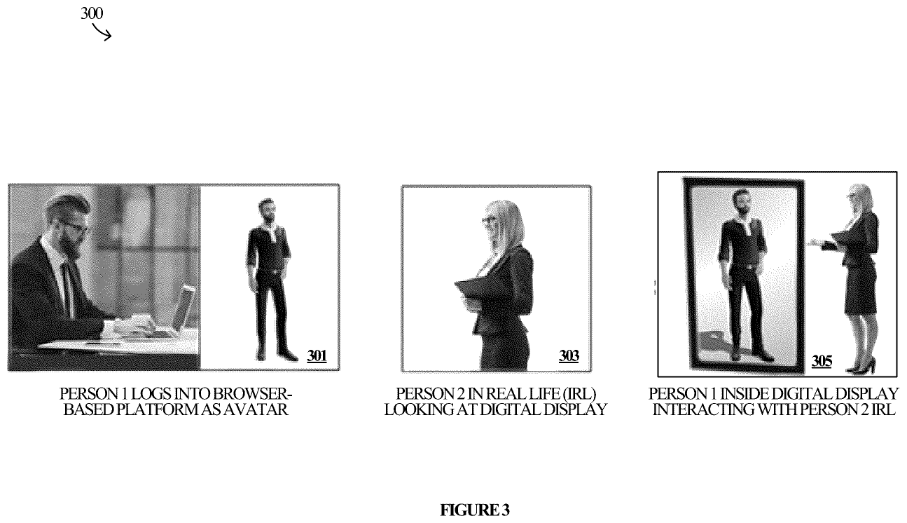

FIG. 3 illustrates an operational scenario 300 in an implementation of the disclosed technology. In operational scenario 300, a remote user (Person 1) wishes to interact with another user (Person 2) at an event that Person 2 is physically attending via a digital interface system. Person 1 on a computing device such as a laptop computer logs into a virtual environment application (e.g., Pathos) through an Internet browser (step 301). The virtual environment application, hosted on a remote server remote, enables one or more users such as Person 1 to virtually visit and interact within a virtual environment. Within the virtual environment, Person 1 and other users interact with the virtual environment by controlling avatar-type representations of themselves. A digital interface system is operatively connected to or embedded within the virtual environment application which provides an interface between the virtual environment and a physical (i.e., real-world) location.

Person 1 maneuvers his avatar to a virtual forum within the virtual environment. The virtual forum is representative of the physical location of a digital display device of the digital interface system, such as at an in-person event. The digital display device is itself represented by a portal, e.g., in the form of a virtual window, in the virtual forum, which may present multiple such portals, each corresponding to a digital display device at various locations at the in-person event.

The digital interface system of the virtual environment application livestreams the avatar of Person 1 to the digital display device. Person 2, who is at the location of the digital display device, sees and hears the avatar of Person 1 presented at the digital display device (step 303). The digital display device captures audio and video of the physical location of the device, particularly the voice and image of Person 2, and transmits a livestream of the audio and video via the digital interface system to the portal within the virtual forum. Person 1 views, hears, and interacts with Person 2 through the presentation of the livestream audio and video at the portal in the virtual environment (step 305). In an implementation, Person 2 or other in-person attendees may be represented within the virtual environment with avatars. Avatars representing in-person attendees may have been preconfigured by the attendee or may be configured in real-time by an avatar-generating module based on the perceived physical characteristics of the attendee.

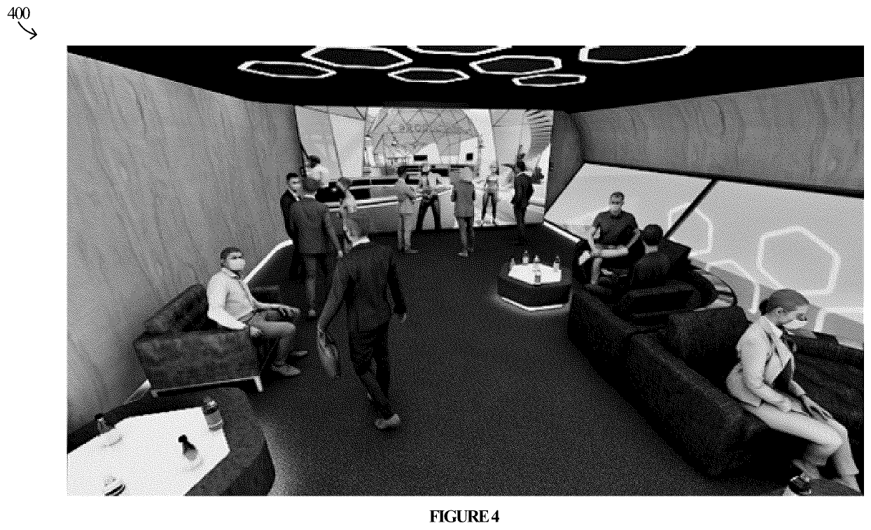

FIG. 4 illustrates operational environment 400 in an alternative implementation. In operational environment 400 is an in-person event with a large digital display device at the far end of the room. The digital display screen displays avatars of remote attendees by streaming real-time audio and video of avatars within a virtual environment from the perspective which simulates a view looking into the virtual environment through a portal or window on the virtual environment. In-person attendees can interact with the avatars through the digital display device which has one or more cameras and microphones to capture the in-person event along with the in-person attendees. The audio and video captured from the in-person event is displayed to the remote attendees at a portal within the virtual forum. As the remote attendees maneuver their avatars about the virtual forum, this activity is displayed on the digital display screen. Thus, a remote attendee, via his or her avatar, may “walk” up to a portal to speak to an in-person attendee near the digital display. The technical effect of the virtual-physical hybrid system is to simulate a scenario in which one person can approach another person as if the first person was actually in the room with the second person. Moreover, the display screen displays multiple avatars representing multiple remote users, each of whom may be accessing the event from a variety of remote locations, creating the effect of gathering the remote users together with in-person attendees in one location.

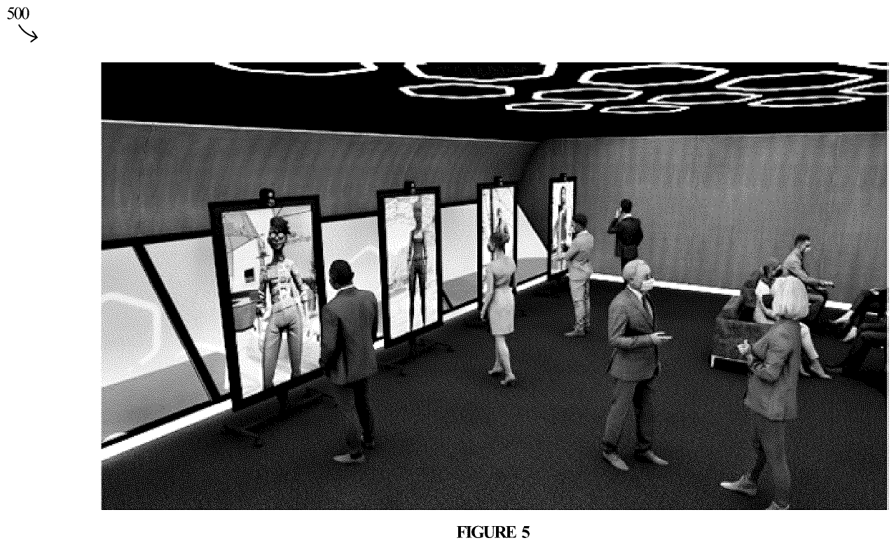

FIG. 5 illustrates another operational environment 500 comprising multiple digital display screens. In operational environment 500, in-person attendees can engage in one-on-one conversation with a remote attendee at a portal. The in-person attendee approaches the digital display device which captures and presents audio and video from the in-person attendee to the remote attendee, and vice versa. Verisimilitude of this scenario is further enhanced by sizing the digital display screens so that the representations of the remote users is life-size. Notably, other in-person attendees can walk up to a display screen to interact with the remote and in-person attendees, just as other remote attendees, executing the system for interfacing with the digital display screens on their respective computing devices, can maneuver their avatars to similarly approach a portal to engage in conversation with another remote attendee and in-person attendee.

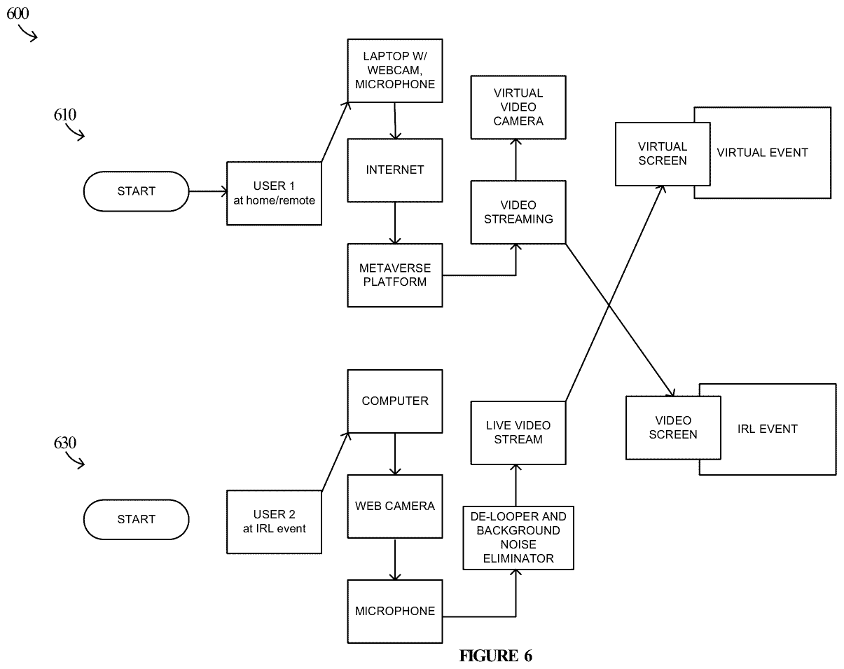

FIG. 6 illustrates operational architecture 600 for a digital interfacing process in an implementation. Process 610 illustrates the architecture for remote User One, who may be a user interfacing with another user, User Two, from home or any other location remote from the User Two. Process 630 illustrates the architecture used by User Two to engage User One or other remote users. User Two's location may be an event, such as a professional networking event or conference, or User Two's workplace, such as a conference room, or any location where a video screen may be displayed by which User Two can interact with User One.

In process 610, remote User One accesses a metaverse platform on a laptop, desktop, or other computing device enabled with or operatively coupled to a video camera (e.g., webcam) and microphone or other audio/video transmitting devices. User One's computing device connects to the metaverse platform operating on a cloud server. In the metaverse platform as viewed from User One's device, User One, as an avatar, attends a virtual event. The virtual event presents one or more virtual screens which display views of the IRL (In Real Life) event captured by one or more video cameras connected to the display screen at the event. User One views User Two at the IRL event via video captured at the display screen.

In process 630, at the IRL event, User Two, positioned in front of the display screen, views the metaverse event. The display screen is operatively coupled to a computing device which connects to the metaverse platform executing on the cloud server. The display screen may include or connect to the one or more video cameras which transmits the image of User Two to the virtual screen at the virtual event. The display screen also includes two-way audio transmission capability, such as a microphone and speakers. The audio transmission capability may include audio filtering capabilities by which audio captured from the IRL event is enhanced for the benefit of User One, such as background noise suppression and de-looping to eliminate feedback.

Within the metaverse platform, User One is represented by an avatar which may be configured to have similar physical characteristics of User One, making it recognizable to other users in the metaverse or to other remote users such as User Two. Simulating User One in human form in the metaverse platform further enhances the ability of other users to engage with User One. The virtual event may be configured to resemble the physical environs of the IRL event to promote visually integration of the display screen into the IRL event.

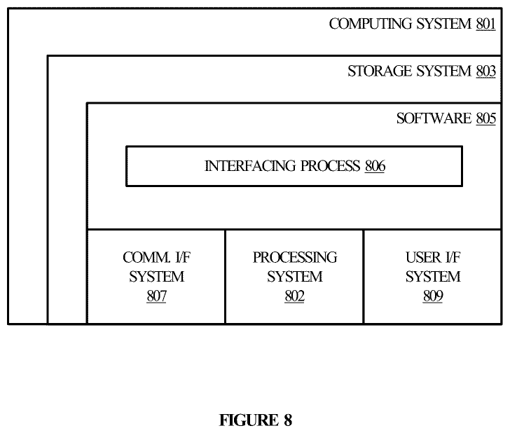

FIG. 8 illustrates an implementation of a digital interface system, where an IRL user views an avatar of a remote user on a display screen which is sized to display the avatar nearly life-sized. Thus, the digital interface system simulates a scenario where the IRL user is speaking with the remote user as if the remote user is in the same room standing in front of the IRL user. The remote user is able to see the IRL user via a web cam attached to the top of the display screen. The IRL user and the remote user are able to interact via real-time audio and video streaming between the two locations. Notably, in various implementations, other remote users can stand before the IRL user simulating a situation where all the users are together in the same room, but with the remote users each physically in different locations around the world.

FIG. 8 illustrates computing device 801 that is representative of any system or collection of systems in which the various processes, programs, services, and scenarios disclosed herein may be implemented. Examples of computing device 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 801 may be implemented as a single apparatus, system, or device or may be implemented in a distributed manner as multiple apparatuses, systems, or devices. Computing device 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements interfacing process 806, which is (are) representative of the interfacing processes discussed with respect to the preceding Figures, such as process 200 of FIG. 2 or processes 610 or 630 of FIG. 6. When executed by processing system 802, software 805 directs processing system 802 to operate as described herein for at least the various processes, operational scenarios, and sequences discussed in the foregoing implementations. Computing device 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, graphical processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including interfacing process 806) may be implemented in program instructions and among other functions may, when executed by processing system 802, direct processing system 802 to operate as described with respect to the various operational scenarios, sequences, and processes illustrated herein. For example, software 805 may include program instructions for implementing an interfacing process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing device 801 is representative) overall from a general-purpose computing system into a special-purpose computing system customized to support a digital interface system in an optimized manner. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A system comprising:
a computing device displaying a virtual environment, wherein the virtual environment comprises a representation of a live event and an avatar of a user, and wherein the computing device is configured to capture audio and video of the user;
a display device; and
a server operating an interface system, the interface system comprising program instructions directing the server to at least:
receive audio of the user from the computing device in real-time;
transmit the audio of the user to the display device;
display an avatar of the user at the display device;
capture real-time audio and video of one or more other users from the display device; and
transmit the audio and video of the one or more other users to the computing device for presentation within the virtual environment.

2. The system of claim 1, wherein the display device comprises a display screen, one or more cameras, one or more microphones, and one or more speakers.

3. The system of claim 2, wherein to display an avatar, the program instructions further direct the server to generate the avatar using an avatar module, wherein the avatar module creates a real-time, dynamic simulation of the user.

4. The system of claim 2, wherein the program instructions further direct the server to:
receive second audio of a second user from a second computing device in real-time;
transmit the second audio of the second user to the display device; and
display a second avatar of the second user at the display device with the avatar of the user.

5. The system of claim 4, wherein the second computing device displays the virtual environment including the avatar of the user.

6. The system of claim 5, wherein the second computing device receives the real-time audio and video of the one or more other users captured from the display device.

7. The system of claim 2, wherein to transmit the audio of the one or more other users to the computing device, the program instructions further direct the server to suppress background noise and feedback in the audio of the one or more other users.

8. A method of operating an interface system, the interface system comprising:
a computing device displaying a virtual environment, wherein the virtual environment comprises a representation of a live event and an avatar of a user, and wherein the computing device is configured to capture audio and video of the user; and
a display device; and
the method comprising:
receiving audio of the user from the computing device in real-time;
transmitting the audio of the user to the display device;
displaying an avatar of the user at the display device;
capturing real-time audio and video of one or more other users from the display device; and
transmitting the audio and video of the one or more other users to the computing device for presentation within the virtual environment.

9. The method of claim 8, wherein the display device comprises a display screen, one or more cameras, one or more microphones, and one or more speakers.

10. The method of claim 9, wherein displaying the avatar comprises generating the avatar using an avatar module, wherein the avatar module creates a real-time, dynamic simulation of the remote user.

11. The method of claim 9, further comprising:
receiving second audio of a second user from a second computing device in real-time;
transmitting the second audio of the second user to the display device; and
displaying a second avatar of the second user at the display device with the avatar of the user.

12. The method of claim 11, wherein the second computing device displays the virtual environment including the avatar of the user.

13. The method of claim 12, wherein the second computing device receives the real-time audio and video of the one or more other users captured from the display device.

14. The method of claim 9, wherein transmitting the audio of the one or more other users to the computing device further comprises suppressing background noise and feedback in the audio of the one or more other users.

15. A method of operating a computing device comprising:
displaying a representation of a physical location in a virtual environment, wherein the virtual environment comprises one or more portals;
displaying a representation of a user within the virtual environment, wherein the representation is based on video of the user captured by the computing device;
displaying within one of the one or more portals a view received from a display device at the physical location; and
playing audio received from the display device at the physical location.

16. The method of claim 15, wherein the display device comprises a display screen, one or more cameras, one or more microphones, and one or more speakers.

17. The method of claim 16, wherein the representation of the user comprises an avatar of the user and wherein displaying the avatar of the user comprises generating the avatar using an avatar module, wherein the avatar module creates a real-time simulation of the user.

18. The method of claim 17, further comprising capturing audio and video and transmitting the captured audio and video to the display screen for display.

19. The method of claim 18, wherein the captured video comprises the avatar of the user.

20. The method of claim 16, further comprising displaying, in the virtual environment, a second avatar of a second user at a second computing device, wherein the second computing device is remote from the physical location.
